(19) United States
(12) Patent Application Publication
(10) Pub. No.: US 2024/0092320 A1
(43) Pub. Date: Mar. 21, 2024

(54) WHEEL WELL THERMAL ENERGY MANAGEMENT SYSTEM AND MANAGEMENT METHOD

(71) Applicant: Ford Global Technologies, LLC, Dearborn, MI (US)

(72) Inventors: Tim Hennicke, Bonn (DE); Karel Chalupa, Leverkusen (DE); Jevon Husapack, Brentwood (GB); Paul Evans, Brentwood (GB); Eugen Weber, Köln (DE)

(21) Appl. No.: 17/969,037

(22) Filed: Oct. 19, 2022

Related U.S. Application Data
(60) Provisional application No. 63/407,244, filed on Sep. 16, 2022.

(51) Int. Cl. B60T 5/00

(52) U.S. Cl. CPC B60T 5/00

(57) ABSTRACT

A wheel well thermal energy management system includes a wheel well liner, and a deflector. The wheel well liner and the deflector both establish a portion of an aperture that is configured to direct a flow of air to a wheel well of a vehicle. A wheel well thermal energy management method includes moving a vehicle and, during the moving, guiding a flow of air through an aperture into a wheel well of the vehicle. The aperture is established by a wheel well liner together with a deflector.

### CROSS-REFERENCE TO RELATED APPLICATIONS

This application claims priority to U.S. Provisional Application No. 63/407,244, which was filed on 16 Sep. 2022 and is incorporated herein by reference.

### TECHNICAL FIELD

This disclosure relates generally to managing thermal energy levels of components within a wheel well of a vehicle, such as brake components.

### BACKGROUND

As a vehicle moves, air moving through wheel wells of the vehicle can help to manage thermal energy levels of brakes and other components. The air moving through the wheel wells can create a zone that is relatively high-pressure, which can contribute to drag. The air moving through the wheel wells can also carry debris and moisture.

### SUMMARY

In some aspects, the techniques described herein relate to a wheel well thermal energy management system, including: a wheel well liner; and a deflector, the wheel well liner and the deflector both establishing a portion of an aperture that is configured to direct a flow of air to a wheel well of a vehicle.

In some aspects, the techniques described herein relate to a system, further including a diverter vertically above the aperture.

In some aspects, the techniques described herein relate to a system, wherein the diverter is provided within the wheel well liner.

In some aspects, the techniques described herein relate to a system, wherein the diverter is a bumped-out region of the wheel well liner.

In some aspects, the techniques described herein relate to a system, wherein and apex of the diverter is directly vertically above the aperture.

In some aspects, the techniques described herein relate to a system, wherein an entire circumferentially perimeter of the aperture is established by the wheel well liner and the air deflector.

In some aspects, the techniques described herein relate to a system, wherein the aperture opens to a vertically lower edge of the deflector.

In some aspects, the techniques described herein relate to a system, further including an underbody tunnel configured to guide the flow of air to the aperture.

In some aspects, the techniques described herein relate to a system, wherein the underbody tunnel is provided by a underbody tunnel of an underbody pan of the vehicle.

In some aspects, the techniques described herein relate to a system, wherein the deflector extends vertically beneath the underbody pan.

In some aspects, the techniques described herein relate to a system, wherein the underbody tunnel tapers upward toward the aperture.

In some aspects, the techniques described herein relate to a system, wherein the deflector is mechanically fastened to the vehicle.

In some aspects, the techniques described herein relate to a system, wherein the aperture is vertically aligned with a brake caliper of the vehicle.

In some aspects, the techniques described herein relate to a wheel well thermal energy management method, including: moving a vehicle; and during the moving, guiding a flow of air through an aperture into a wheel well of the vehicle, the aperture established by a wheel well liner together with a deflector.

In some aspects, the techniques described herein relate to a method, wherein the aperture is vertically aligned with a brake component of the vehicle, the flow of air cooling the brake component.

In some aspects, the techniques described herein relate to a method, further including diverting moisture around the aperture and around the flow of air moving passing through the aperture.

In some aspects, the techniques described herein relate to a method, further including using a bumped-out region of the wheel well liner for the diverting.

In some aspects, the techniques described herein relate to a method, further including guiding the flow of air to the aperture using an underbody tunnel that is recessed upward within an underbody pan of the vehicle.

In some aspects, the techniques described herein relate to a method, wherein the deflector is a first deflector, and further including replacing the first deflector with a different, second deflector to change a size of the aperture.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a thermal management system incorporating a deflector according to an exemplary aspect of the present disclosure.

FIGS. 1A-1C illustrate close-up views of thermal management systems having deflectors according to other exemplary embodiments.

FIG. 2 illustrates a perspective view of selected portions of the thermal management system assembly of FIG. 1 showing a direction of air flow through the air deflector.

FIG. 3 illustrates another view of the system of FIG. 1 looking rearward from a position in front of the deflector.

### DETAILED DESCRIPTION

This disclosure details a system and method of managing thermal energy within components within a wheel well of a vehicle. Examples of these components include brake components.

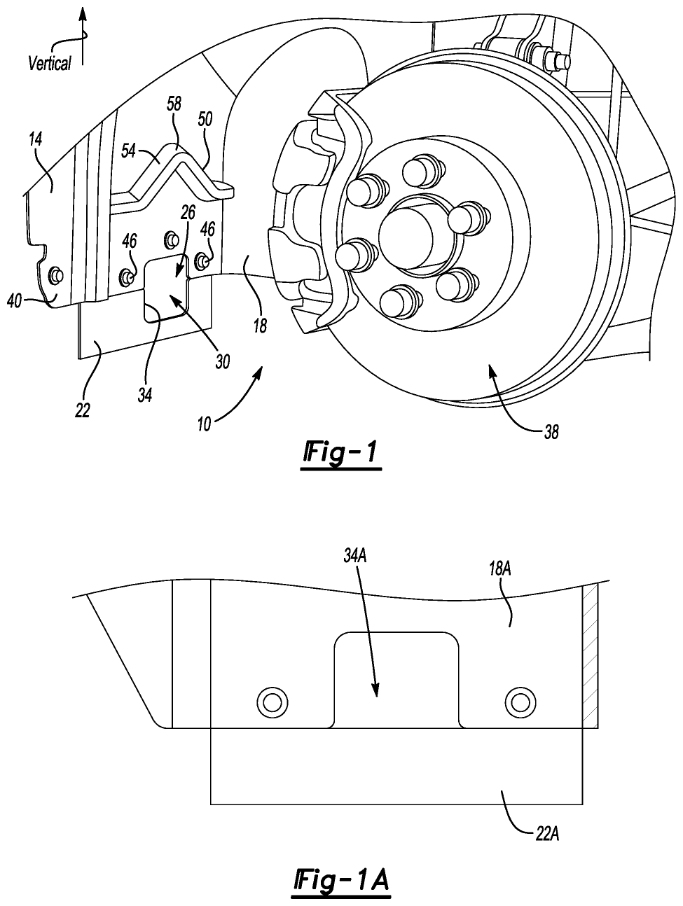

With reference to FIG. 1, a wheel well 10 of a vehicle 14 includes a wheel well liner 18 and a deflector 22. The wheel well liner 18 can be a polymer-based trim component that lines the wheel well 10. The deflector 22 is to the vehicle 14 adjacent the wheel well liner 18. The deflector 22 extends vertically beneath the wheel well liner 18. Vertical, for purposes of this disclosure is with reference to ground and a general orientation of the vehicle 14 during ordinary operation. As the vehicle 14 is driven the deflector 22 directs (or “deflects”) some air from moving into the wheel well 10 and against a wheel (not shown). In so doing, the deflector 22 can enhance aerodynamics and help to manage drag. Aerodynamic enhancements, however, are balanced with other factors, such as managing thermal energy levels.

The wheel well liner 18 includes a notched area 26. The deflector 22 includes a notched area 30 that, together with a notched area 26 of the wheel well liner 18, establish an aperture 34.

In this example, both the wheel well liner 18 and the deflector 22 are notched to provide the aperture 34. Further, in this example, an entire circumferential perimeter of the aperture 34 is established by the wheel well liner 18 and the deflector 22.

In other examples, only one of the wheel well liner 18 or the deflector 22 is notched to provide the aperture 34. FIG. 1A show an example of a wheel well liner 18A notched to provide an aperture 34A, while the deflector 22A is not notched. FIG. 1B shows an example of a deflector notched 22B to provide an aperture 34B. The wheel well liner 18B is not notched.

In another example, as shown in FIG. 1C, only a portion of a perimeter of an aperture 34C is established by a wheel well liner 18C and a deflector 22C. The aperture 34C established by the wheel well liner 18C and the deflector 22C opens vertically downward to a vertically lower edge of the deflector 22C.

Referring again to FIG. 1, the vehicle 14 includes a plurality of wheel well components 38 disposed within the wheel well 10. The wheel well components 38 can include, but are not limited to, a hub, brake pads, brake lines, brake caliper, etc.

A front wheel of the vehicle 14 is not shown in FIG. 1 for drawing clarity. During operation of the vehicle 14, the front wheel would be attached to the hub. The front wheel could also be a wheel well component. While shown in connection with the wheel well 10 for a front wheel of the vehicle 14, the teachings of this disclosure could apply to the wheel wells for the rear wheels.

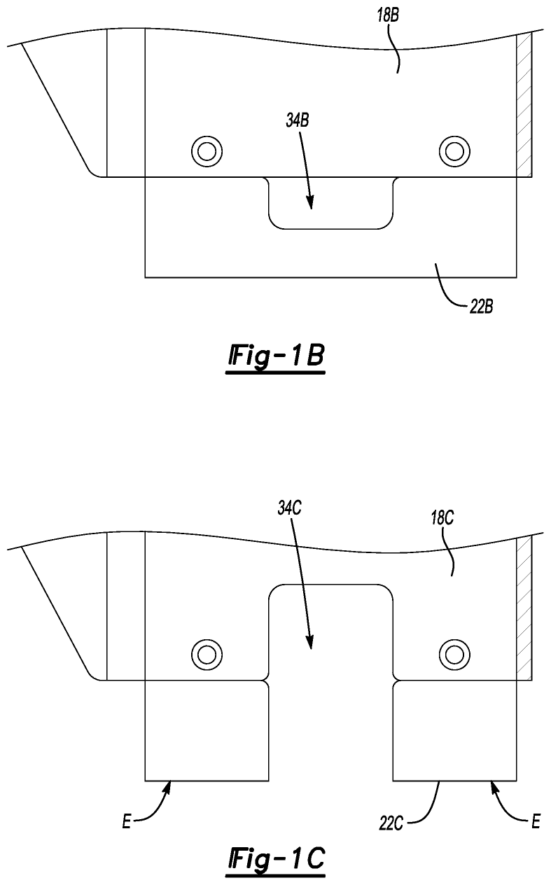

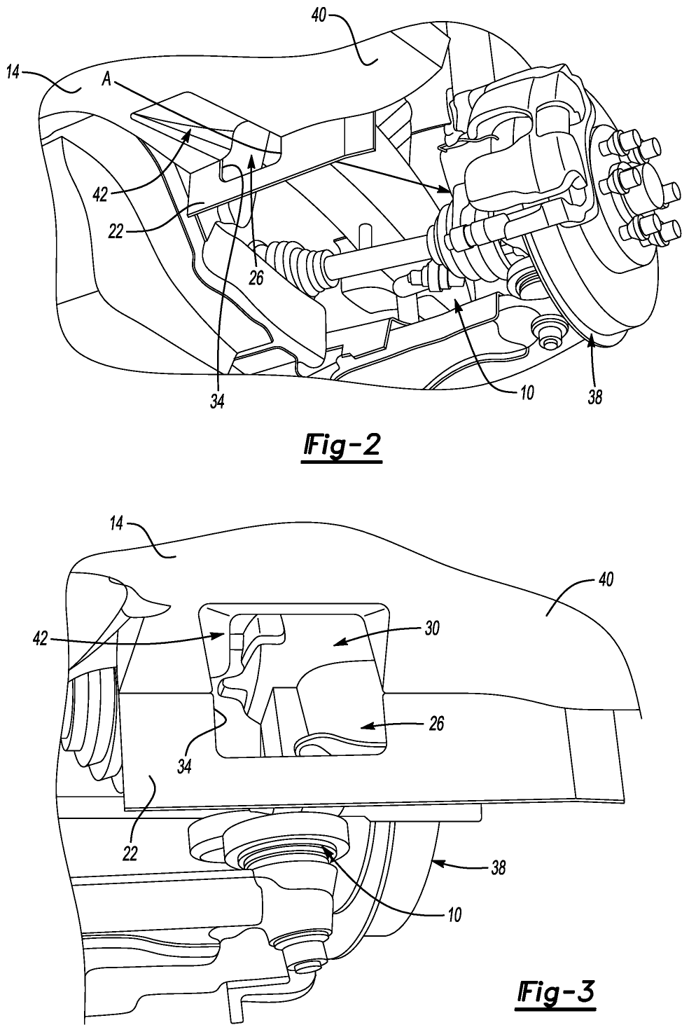

With reference now to FIGS. 2-3 and continued reference to FIG. 1, the deflector 22 is secured in a position forward the wheel well components 38. The aperture 34 is also forward the wheel well components 38. As the vehicle 14 is driven, a flow of air A passes along an underbody pan 40 of the vehicle 14.

The example underbody pan 40 includes an underbody tunnel 42 that guides some of the flow of air A vertically upward and through the aperture 34 to the wheel well 10. The underbody tunnel 42 is recessed upward within the underbody pan 40. Moving rearward along the vehicle 14, the underbody tunnel 42 tapers upward toward the aperture 34, which is at least partially vertically aligned with the wheel well components 38. The deflector 22 extends, in this example, vertically downward past the underbody pan 40.

The aperture 34 is vertically aligned with at least some of the wheel well components 38. In particular, in this example, the aperture 34 is aligned with the brake caliper. Vertically aligning the aperture 34 with the wheel well components 38 helps to guide direct the flow of air against the wheel well components 38, which facilitates cool the wheel well components 38. The underbody tunnel 42 provides a passageway for the flow of air A to move vertically upward to the aperture 34.

The underbody tunnel 42 and aperture 34 can be consider a “jet tunnel” for air A to pass to the wheel well 10 from the underbody pan 40. The flow or air A is guided toward a brake caliper of the vehicle 14 by the underbody tunnel 42 and the aperture 34. Notably, how a flow of air is introduced to the wheel well 10 can be changed by adjusting a size of the aperture 34.

As the aperture 34 is at least partially established by the deflector 22, adjusting a size of the aperture 34 can be accomplished by changing a position of the deflector 22 or by swapping the deflector 22 for another deflector.

The deflector 22 can be selected based on a desired size for the aperture 34. During assembly, a plurality of different types of deflectors could be available for use. The different types of the deflectors can include deflectors larger notches and deflectors having smaller notches, for example. An assembler could select a deflector having a notch size that, when secured adjacent the wheel well liner 18 establishes a desired size for the aperture 34. A size of the aperture can be set when assembling the vehicle 14 by selecting a particular deflector from among the plurality of deflectors having differently sized notches.

Instead or additionally, the positioning of the deflector 22 when secured adjacent the wheel well liner 18 can be an adjusted to change the size of the aperture. Lowering the deflector 22 can provide a larger aperture, and raising the deflector 22 can provide a smaller aperture.

For example, the example deflector 22 could be secured in a position that is vertically raised from the position shown in FIG. 1 to provide a smaller aperture, or secured in a position that is vertically lower than the position shown in FIG. 1 to provide a larger aperture. The deflector 22 can be secured to the vehicle 14 using mechanical fasteners 46, for example.

Using a deflector to partially establish the aperture 34 facilitates using a common wheel well liner across various vehicle models. Different sized apertures can be implemented as desired by selecting a deflector having a particular notch size, by attaching a deflector in a different position relative to the wheel well liner 18, or both. Such a deflector can be considered an adjustable deflector.

A different sized aperture may be selected to account for different vehicle models having brake calipers positioned in different areas or having different wheel sizes, for example. If a flow of air to the wheel well area through an aperture for a particular vehicle is not desired, the deflector 22 and underbody tunnel 42 could be concealed by a piece of trim.

In the exemplary embodiment, the wheel well liner 18 includes a diverter 50 that is vertically above the aperture 34. The example diverter 50 is a bumped-out region of the wheel well liner 18. The diverter 50 includes a peak 54 terminating at an apex 58 that is directly vertically above the aperture 34. The peak 54 tapers vertically downward from the apex 58 to inboard and outboard sides of the aperture 34. The peak 54 facilitates redirecting water and debris around the aperture 34.

As the vehicle 14 is driven, water and debris splashed onto the wheel well liner 18 above the diverter 50 flow downward along the wheel well liner 18. Upon reaching peak 54, the water and debris are redirected around the aperture 34. Accordingly, the water and debris that are redirected do not drip into the flow of air A passing through the aperture 34. Water and debris dripping into the flow of air passing through the aperture 34 could be potentially be directed onto the brake disc, caliper, and other components within the wheel well 10. The diverter 50 directs water and debris away from the flow of air A passing through the aperture 34.

Redirecting water and debris away from components of the vehicle 14 can facilitate braking performance and brake pedal feel during wet conditions. Further, by redirecting water around the aperture, the potential for water being absorbed into the brake fluid can be reduced.

A wheel well thermal energy management method utilizing the exemplary embodiments of this disclosure can include moving the vehicle 14 and using the underbody tunnel 42 to guide some of the flow of air upward through the aperture 34 into the wheel well of the vehicle 14. The aperture 34 is vertically aligned with a wheel well component of the vehicle 14. The aperture 34 is established by the wheel well liner 18 and the deflector 22. The deflector 22 can be replaced with another deflector to change a size of the aperture 34.

The flow of air A passing through the aperture 34 can cool the wheel well component. As the flow of air A moves through the aperture 34, moisture is diverted around the aperture 34 and around the flow of air A by the diverter 50.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A wheel well thermal energy management system, comprising:
a wheel well liner; and
a deflector, the wheel well liner and the deflector both establishing a portion of an aperture that is configured to direct a flow of air to a wheel well of a vehicle.

2. The system of claim 1, further comprising a diverter vertically above the aperture.

3. The system of claim 2, wherein the diverter is provided within the wheel well liner.

4. The system of claim 3, wherein the diverter is a bumped-out region of the wheel well liner.

5. The system of claim 4, wherein an apex of the diverter is directly vertically above the aperture.

6. The system of claim 1, wherein an entire circumferentially perimeter of the aperture is established by the wheel well liner and the air deflector.

7. The system of claim 1, wherein the aperture opens to a vertically lower edge of the deflector.

8. The system of claim 1, further comprising an underbody tunnel configured to guide the flow of air to the aperture.

9. The system of claim 8, wherein the underbody tunnel is provided by a underbody tunnel of an underbody pan of the vehicle.

10. The system of claim 9, wherein the deflector extends vertically beneath the underbody pan.

11. The system of claim 9, wherein the underbody tunnel tapers upward toward the aperture.

12. The system of claim 1, wherein the deflector is mechanically fastened to the vehicle.

13. The system of claim 1, wherein the aperture is vertically aligned with a brake caliper of the vehicle.

14. A wheel well thermal energy management method, comprising:
moving a vehicle; and
during the moving, guiding a flow of air through an aperture into a wheel well of the vehicle, the aperture established by a wheel well liner together with a deflector.

15. The method of claim 14, wherein the aperture is vertically aligned with a brake component of the vehicle, the flow of air cooling the brake component.

16. The method of claim 14, further comprising diverting moisture around the aperture and around the flow of air moving passing through the aperture.

17. The method of claim 16, further comprising using a bumped-out region of the wheel well liner for the diverting.

18. The method of claim 14, further comprising guiding the flow of air to the aperture using an underbody tunnel that is recessed upward within an underbody pan of the vehicle.

19. The method of claim 14, wherein the deflector is a first deflector, and further comprising replacing the first deflector with a different, second deflector to change a size of the aperture.
